(19) United States
(12) Patent Application Publication
(10) Pub. No.: US 2018/0347265 A1
(43) Pub. Date: Dec. 6, 2018

(54) APPARATUS FOR PROVIDING PROTECTION TO A STRUCTURE

(71) Applicant: Carey Gerald Bolt, Discovery Bay (JM)

(72) Inventor: Carey Gerald Bolt, Discovery Bay (JM)

(21) Appl. No.: 15/993,539

(22) Filed: May 30, 2018

Related U.S. Application Data
(60) Provisional application No. 62/512,415, filed on May 30, 2017.

(51) Int. Cl. E06B 9/00; E04H 9/14; E04H 9/16

(52) U.S. Cl. CPC E06B 9/00; E04H 9/16; E04H 9/145

(57) ABSTRACT

Disclosed is an apparatus for providing protection to a structure. The apparatus may include at least one protective sheet configured to be maintained in one of a collapsed state and an extended state. In the extended state, the at least one protective sheet may be configured to cover at least a portion of the structure. Further, the apparatus may include at least one holder configured to house the at least one protective sheet. Further, the apparatus may include at least one actuator configured to transition the at least one protective sheet from one of the collapsed state and the extended state to an opposite state. Further, the apparatus may include at least one power source configured to supply electric power to the at least one actuator. Further, the apparatus may include at least one switch communicatively coupled the at least one actuator and the at least one power source.

### FIELD OF THE INVENTION

The present invention relates generally to weather protection. In particular, the present invention relates to an apparatus for protecting properties against harsh weather, such as flood waters and hail.

### BACKGROUND OF THE INVENTION

According to a report by the UN, “The Human Cost of Weather Related Disasters”, floods affected 2.3 billion people between 1995 and 2015. This accounts for 56% of all those affected by weather-related disasters—considerably more than any other type of weather-related disaster. In the US, several states were flooded in 2017, which lead to considerable loss of life and property damaged caused by hail and water.

Currently, the residents of a flood affected area are warned to relocate to safe locations before the flood waters rise. However, some residents may not be able to evacuate flood-affected areas in time. This may lead to loss of life. Further, the residents who are able to evacuate flood are unable to save their properties in the flood-affected areas. This may lead to loss of property.

Accordingly, there is a need for improved apparatus for protecting homes and businesses from flood waters and hail that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is an apparatus for providing protection to a structure. The apparatus may include at least one protective sheet configured to be maintained in one of a collapsed state and an extended state. Further, in the extended state, the at least one protective sheet may be configured to cover at least a portion of the structure. Further, the at least one protective sheet may be configured to protect the portion of the structure from an environmental adversity. Further, the apparatus may include at least one holder configured to house the at least one protective sheet. Further, the at least one holder may be configured to be secured to one or more of the structure and the ground. Further, the apparatus may include at least one actuator configured to transition the at least one protective sheet from one of the collapsed state and the extended state to an opposite state. Further, the apparatus may include at least one power source configured to supply electric power to the at least one actuator. Further, the apparatus may include at least one switch communicatively coupled the at least one actuator and the at least one power source. Further, the at least one switch may be configured to control a supply of power to the at least one actuator based on at least one user input.

According to some aspects, an apparatus for weather protection is disclosed. The apparatus protects properties (such as homes and businesses) from flood waters and hail. The apparatus includes a plastic-like material which, when activated whether manually or wirelessly, is deployed around the entire perimeter of a property to make the property waterproof.

The present disclosure provides multiple advantages including saving lives, protecting properties (homes/businesses), protecting items inside properties, adding value to properties, lower insurance premiums for properties, getting tax breaks/credit, and allowing users to activate protection apparatus wirelessly from anywhere in the World.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 illustrates an apparatus for providing protection to a structure in accordance with an exemplary embodiment.

FIG. 3 illustrates an air/hydraulics motor in accordance with an exemplary embodiment.

FIG. 4 illustrates a battery in accordance with an exemplary embodiment.

FIG. 5 illustrates a solar panel in accordance with an exemplary embodiment.

FIG. 6 illustrates a wireless remote in accordance with an exemplary embodiment.

FIG. 7 illustrates a water sensor in accordance with an exemplary embodiment.

FIG. 8 illustrates the movement associated with one or more protective sheets, in accordance with an exemplary embodiment.

FIG. 9 illustrates a guide-rail in accordance with an exemplary embodiment.

FIG. 10 illustrates a guide-rail with a bend in accordance with an exemplary embodiment.

FIG. 11 illustrates a magnetic lock in accordance with an exemplary embodiment.

FIG. 12 illustrates a brush in accordance with an exemplary embodiment.

FIG. 13 illustrates push wheels in accordance with an exemplary embodiment.

FIG. 14 illustrates a holder in accordance with an exemplary embodiment.

FIG. 15 illustrates a holder in accordance with an exemplary embodiment.

FIG. 16 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of weather protection, embodiments of the present disclosure are not limited to use only in this context.

### Overview

According to some aspects, the present disclosure provides an apparatus for providing protection to a structure. The apparatus may include one or more of a flood protection holder, a battery, an electronic motor, a Wi-Fi sensor, a wireless remote, protection sheets, a pulley, a magnetic end lock, a magnetic strip lock for upper roof, a magnetic strip for ground level, a top protection sheet magnetic liner, a bottom protection sheet magnetic liner, a solar panel, a water sensor, an inflatable inner tube, an air pump for tube, a debris brush, a flat metal strip to frame protection sheets, shafts for the protective sheets to be wrap around inside flood holder, a double flood protection holder, green bulb(s) (for indicating OCCUPIED status), and a red bulb(s) (for indicating UNOCCUPIED status).

In further aspects, a smart flood protection apparatus is disclosed. The apparatus includes a wireless network capability (such as Wi-Fi or its own Sim card) to send alerts to users (for example, via email). The alerts may be related to weather conditions in the vicinity, device information like battery level, or if something is on the ground strip and the water level that's outside your property. For example, the smart flood protection apparatus may use keywords (like severe flooding, Heavy rain, flash flood, etc.) to search and obtain information related to weather conditions in the vicinity. When it picks up words like that, in or around your location the device will send the user an email informing of weather conditions so if you're not home you can make a decision if you want to activate the flood protection system or not. A user may access the apparatus (for example, via a software application) to activate the smart flood protection apparatus.

According to some aspects, the disclosure provides an apparatus for providing protection to a structure. The apparatus may be installed at the rear of the structure. When activated, the apparatus moves one or more protective sheets around the structure, which then lock to seal the property. Further, one or more protective sheets rises towards roof and lock with the roof to seal the property.

The disclosed apparatus may be used to protect a row house (or property that's from side to side front entrance). Further, the apparatus may be used to protect multiple floors of a property.

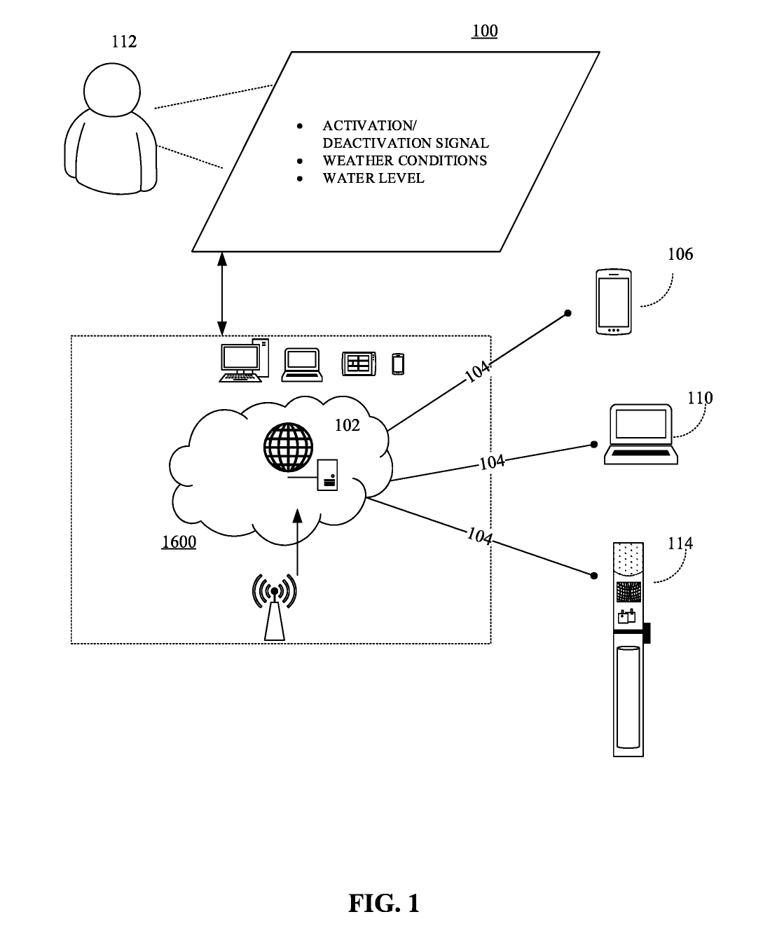

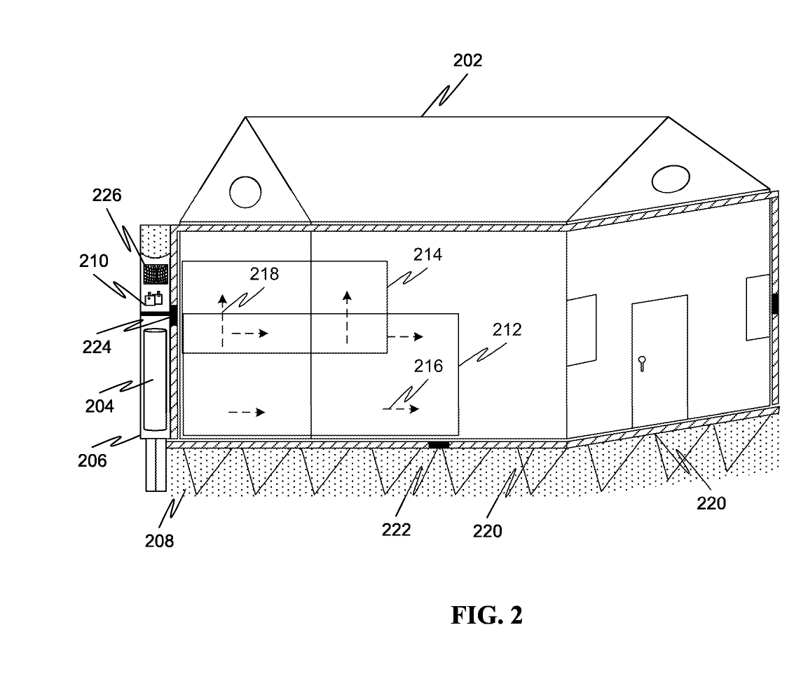

Referring now to figures, FIG. 1 is an illustration of a platform 100 consistent with various embodiments of the present disclosure. By way of non-limiting example, the online platform 100 for providing protection to a structure may be hosted on a centralized server 102, such as, for example, a cloud computing service. The centralized server 102 may communicate with other network entities, such as, for example mobile devices 106 (such as a smartphone, a laptop, a tablet computer etc.), special electronic devices 108, other electronic devices 110 (such as desktop computers, etc.), an apparatus 114 for providing protection to a structure over a communication network 104, such as, but not limited to, the Internet. The apparatus 114 has been explained in further detail in conjunction with FIGS. 2-15 below. Further, users of the platform may include one or more relevant parties such as users, emergency response teams, and system administrators. Accordingly, electronic devices operated by the one or more relevant parties may be in communication with the platform 100.

A user 116, such as the one or more relevant parties, may access platform 100 through a software application. The software application may be embodied as, for example, but not be limited to, a website, a web application, a desktop application, and a mobile application compatible with a computing device 1600.

FIG. 2 illustrates the apparatus 114 for providing protection to a structure 202 in accordance with an exemplary embodiment. The structure 202 may be a house building or a commercial building, such as a hotel or an office. Further, the structure 202 may have any height, size or shape.

Further, the apparatus 114 may include one or more protective sheets 204 configured to be maintained in one of a collapsed state and an extended state. The length(s) of one or more protective sheets 204 may depend on the size of the structure 202. The one or more protective sheets 204 may be wound and stored in one of a vertical orientation and a horizontal orientation. Further, the one or more protective sheets 204 may include reinforcements, such that in the collapsed state the one or more protective sheets 204 are compressed. Therefore, as soon as the one or more protective sheets 204 are released they go into their normal extended state. For example, the one or more protective sheets 204 may be made from one or more of a polypropylene fabric and a waterproof rubber. Further, the one or more protective sheets 204 may be transparent to visible light.

Further, in the extended state, the one or more protective sheets 204 may be configured to cover at least a portion of the structure 202. Further, the one or more protective sheets 204 may be configured to protect the portion of the structure 202 from an environmental adversity. For example, the environmental adversity may include one or more of, but is not limited to, a flood, a hail storm, a rain, a blizzard and a strong wind. Therefore, in a flood situation, the one or more protective sheets 204 may be configured to protect the bottom portion of the structure 202 from flood waters. Similarly, during a hail storm, the one or more protective sheets 204 may be configured to protect the windows of the structure 202.

Further, the apparatus 114 may include one or more holders 206 configured to house the one or more protective sheets 204. Further, the one or more holders 206 may be further configured to be secured to one or more of the structure 202 and the ground 208. Moreover, the one or more holders 206 may go down into the ground 208, wherein they may be cemented in place. For example, the one or more holders 206 may go down by one feet into the ground 208, such that each holder in the one or more holders 206 is able to hold itself without any support from the structure 202. Moreover, each holder in the one or more holders 206 may include a waterproof emergency door. A user may open the waterproof emergency door to deactivate/activate the apparatus 114 for maintenance. Further, an exterior surface of the one or more holders 206 may be colored to match the color of the structure 102.

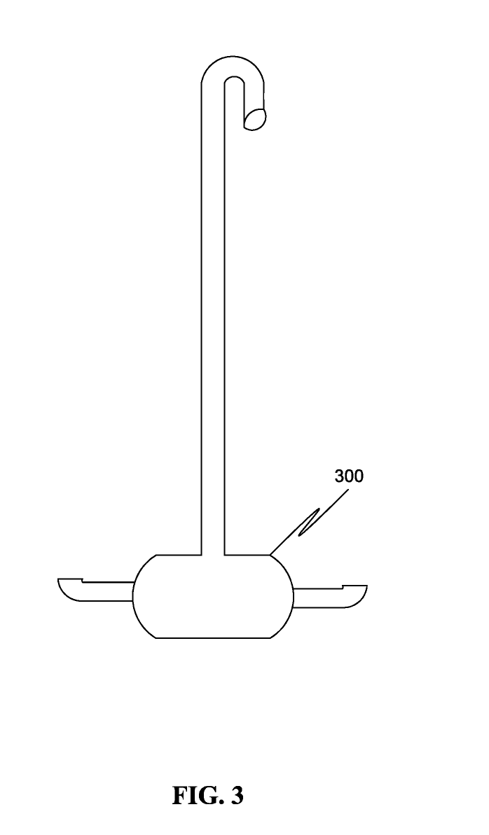

Further, the apparatus 114 may include one or more actuators (not shown) configured to transition the one or more protective sheets 204 from one of the collapsed state and the extended state to an opposite state. In some embodiments, the one or more actuators may include a shaft coupled to the one or more protective sheets 204. The one or more protective sheets 204 may be wound around the shaft. Further, rotation of the shaft causes one or more of winding and unwinding of the one or more protective sheets 204 around the shaft. Moreover, the one or more actuators may include one or more electric motors rotatably coupled to the shaft. The one or more electric motors may be configured to rotate the shaft. Further, the one or more electric motors may include an air/hydraulics motor 300 shown in FIG. 3.

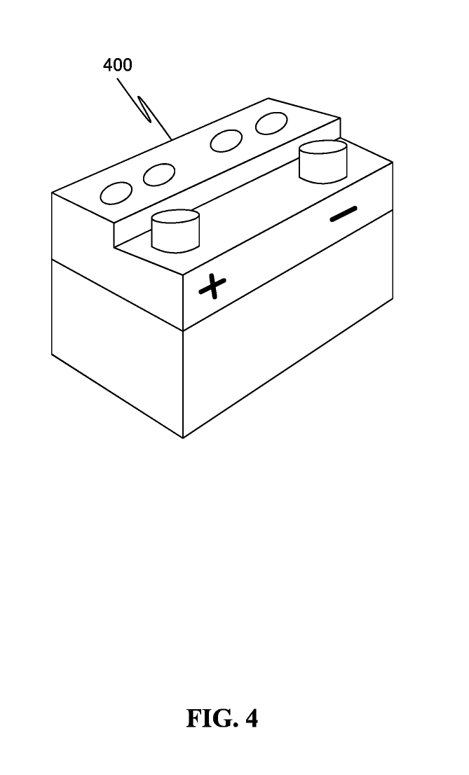

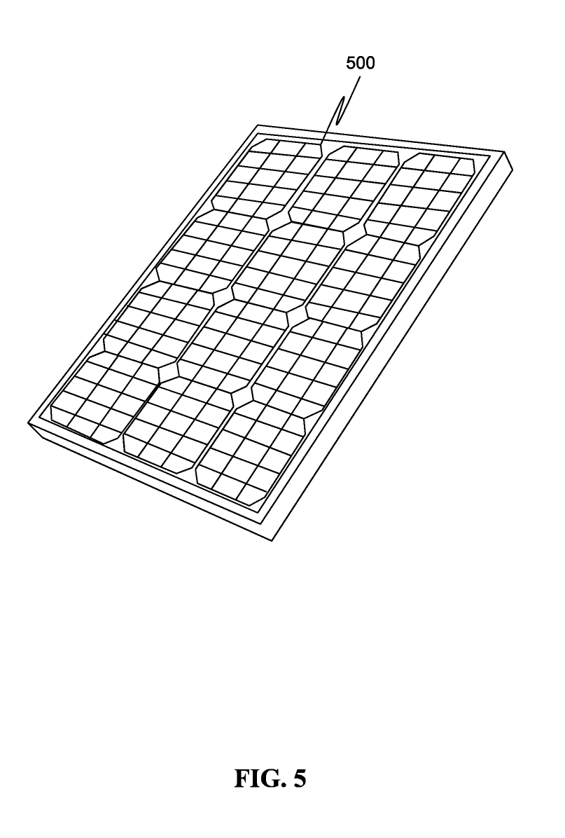

Further, the apparatus 114 may include one or more power sources 210 configured to supply electric power to the one or more actuators. The one or more power sources 210 may include a battery 400 shown in FIG. 4. The battery 400 when fully charged may last for a few days and continue supplying electric power to the one or more actuators. For example, the battery 400 may be one of a lead-acid battery, a nickel-cadmium battery (NiCd), a nickel-metal hydride battery (NiMH), a lithium-ion battery and a Lithium-ion polymer batteries (LiPo). The one or more power sources 210 may also include a solar panel 500 shown in FIG. 5. The solar panel 500 may be installed on top of one of the structure 202 and the one or more holders 206. The battery may be charged via the solar panel 500. In further embodiments, one or more solar panels may be disposed over the one or more protective sheets 204. The one or more solar panels may be flexible solar panels. Further, the one or more power sources 210 may include the one or more solar panels disposed over the one or more protective sheets 204. Further, the one or more power sources 210 may also include a grid power supply to charge the battery 400.

Further, the apparatus 114 may include one or more switches (not shown) communicatively coupled the one or more actuators and the one or more power sources 210. Further, the one or more switches may be configured to control a supply of power to the one or more actuators based on one or more user inputs. For example, the one or more switches may include a physical switch installed within the structure 202. A user may use the physical switch to control the supply of power to the one or more actuators.

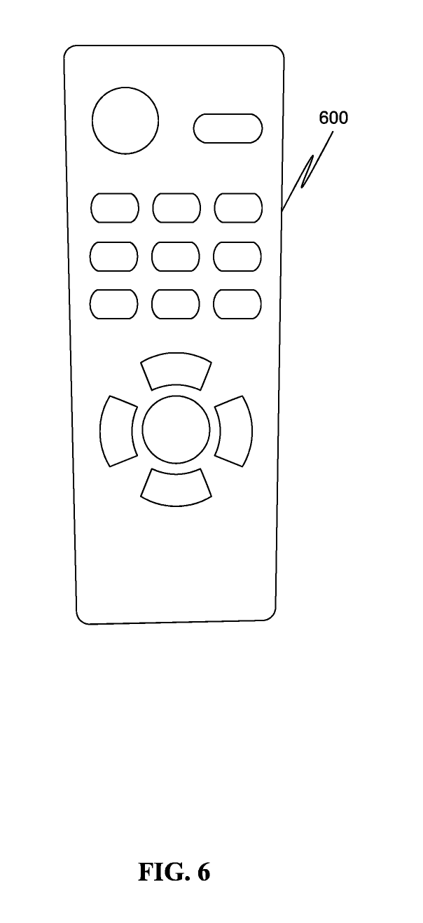

In further embodiments, the apparatus 114 may include a wireless communication device configured to receive one or more commands over a communication channel. Further, the apparatus 114 may include a processing device communicatively coupled to the wireless communication device. The processing device may be configured to interpret the one or more commands. Further, the processing device may be communicatively coupled to the one or more switches. Further, the processing device may be configured to control a state of the one or more switches based on the one or more commands. For example, a user may use a wireless remote 600 (shown in FIG. 6) to send the one or more commands over a communication channel to the wireless communication device. For example, the wireless remote 600 may use a AAA battery. Further, the wireless remote 600 may include a screen to show one or more functions.

In further embodiments, the wireless communication device may be configured to receive weather data associated with a location of the structure 202 from one or more weather databases. For example, the one or more weather databases may include, but is not limited to, National Digital Forecast Database (NDFD) and World Weather Information Service (WWIS). Further, the processing device may be configured to analyze the weather data and control a state of the one or more switches based on analysis of the weather data. Therefore, the processing device may activate the one or more actuators automatically without any input from the user. For example, the processing device may activate the one or more actuator based on weather conditions, such as a heavy rainfall.

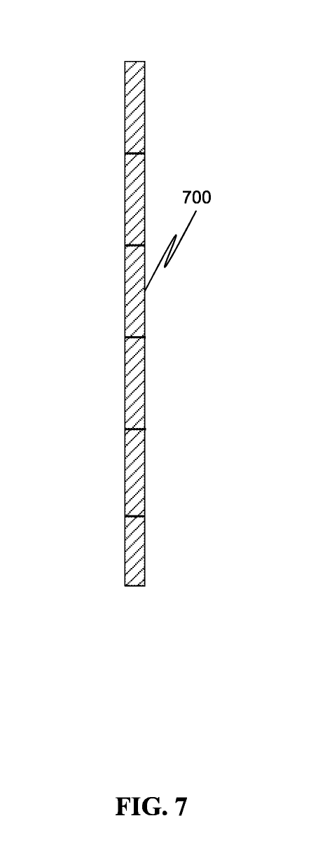

In some embodiments, the apparatus 114 may further include one or more sensors configured to detect an environmental variable. For example, the one or more sensors may include a water sensor 700 shown in FIG. 7. Further, the one or more sensors may be communicatively coupled to the processing device. The processing device may be further configured to analyze the environmental variable and control a state of the one or more switches based on analysis of the environmental variable. Therefore, the processing device may activate the one or more actuators automatically without any input from the user. For example, the processing device may activate the one or more actuators based on a water level detected by the water sensor 700.

In further embodiments, the wireless communication device may be configured to transmit the environmental variable to a user device over the communication channel. The user device may be one of a smartphone, a table, a laptop, and a desktop. Further, a software application installed on the user device may receive the environmental variable and provide an output. The output may be an audio or a visual display. Further, the software application may allow the user to remotely check the weather conditions near the structure 202. For example, the user may remotely check the water level around the structure 202.

In some embodiments, the one or more protective sheets 204 may include one or more light sources configured to produce light according to one or more patterns. Further, the one or more patterns may be based on a user input of the one or more user inputs. The one or more patterns may be used to indicate if the structure 202 is occupied or not. For example, the one or more patterns may include a text “OCCUPIED” displayed in red color light to indicate that the structure 202 is occupied. Accordingly, in an emergency situation, an emergency response team near the structure 202 may read the text “OCCUPIED” displayed in red color light and try to rescue the one or more users in the structure 202. Further, the one or more patterns may include a text “UNOCCUPIED” displayed in green color light to indicate that the structure 202 is unoccupied. Accordingly, in an emergency situation, an emergency response team near the structure 202 may read the text “UNOCCUPIED” displayed in green color light and decide to skip the structure 202. This will save their time and help them in executing rescue operations effectively.

In some embodiments, the one or more protective sheets 204 may include multiple protective sheets. Further, the one or more actuators may include multiple actuators. Further, a first protective sheet 212 of the multiple protective sheets may be configured to cover a first portion of the structure 202. Further, a second protective sheet 214 of the multiple protective sheets may be configured to cover a second portion of the structure 202. For example, the first protective sheet 212 may have 1′-1.5′ width for the second protective sheet 214 to fit inside of it. The second protective sheet 214 may be 1′ thick for cushion and strength. Further, the second protective sheet 214 may be transparent. Further, each of the first protective sheet 212 and the second protective sheet 214 may have double layers for more water protection. Further, the first portion of the structure 202 may be 4 ft. up from the ground and the second portion of the structure 202 may be another 4 ft. above the first portion.

Further, the supply of power to the first actuator may be independent of the supply of power to the second actuator.

Further, the first actuator may be configured to transition the first protective sheet 212 from one of the collapsed state and the extended state to an opposite state. Further, the second actuator may be configured to transition the second protective sheet 214 from one of the collapsed state and the extended state to an opposite state. In the collapsed state, the second protective sheet 214 may be nested within the first protective sheet 212.

In further embodiments, the second protective sheet 214 may be configured to be inflatable. Therefore, the collapsed state of the second protective sheet 214 may include a deflated state and the extended state of the second protective sheet 214 may include an inflated state. Further, the second actuator may include an air pump configured to control a volume of air contained within the second protective sheet 214. The air pump may be the air/hydraulics motor 300.

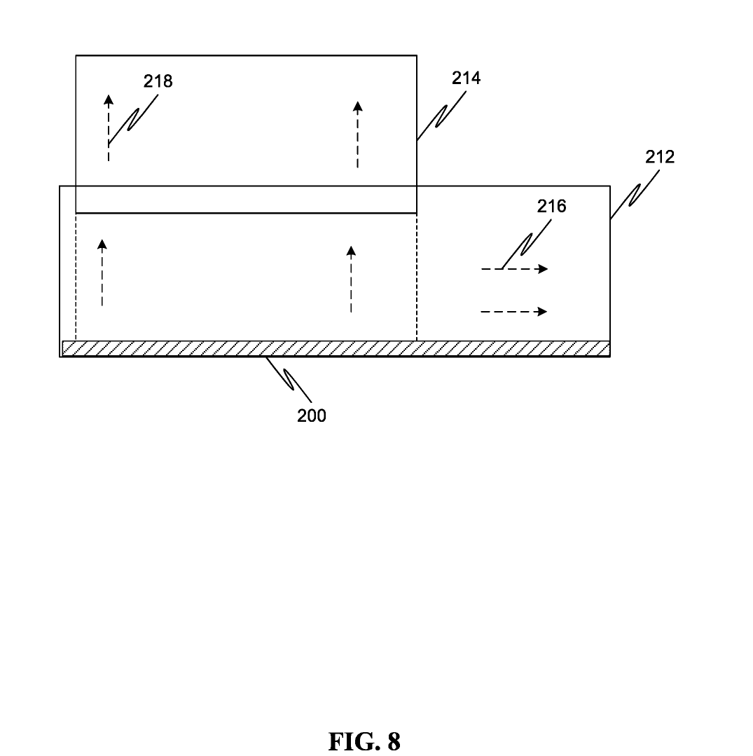

FIG. 8 illustrates the movement associated with one or more protective sheets, in accordance with an exemplary embodiment. A first direction 216 of movement associated with the transition of the first protective sheet 212 may be orthogonal to a second direction 218 of movement associated with the transition of the second protective sheet 214. Accordingly, the first protective sheet 212 may go around the entire perimeter of the structure 202. Further, the second protective sheet 214 may rise up above the first protective sheet 212 to reach a roof of the structure 202. For example, the first protective sheet 212 may cover a 4 ft. tall portion around the perimeter of the structure 202. The second protective sheet 214 may rise another 4 ft. to secure 8 ft. high around the entire perimeter of the structure 202. A top edge of the second protective sheet 214 may include a magnetic material. Therefore, the second protective sheet 214 may engage with a magnetic strip permanently installed on the roof. The magnetic strip may be colored so that it is camouflaged.

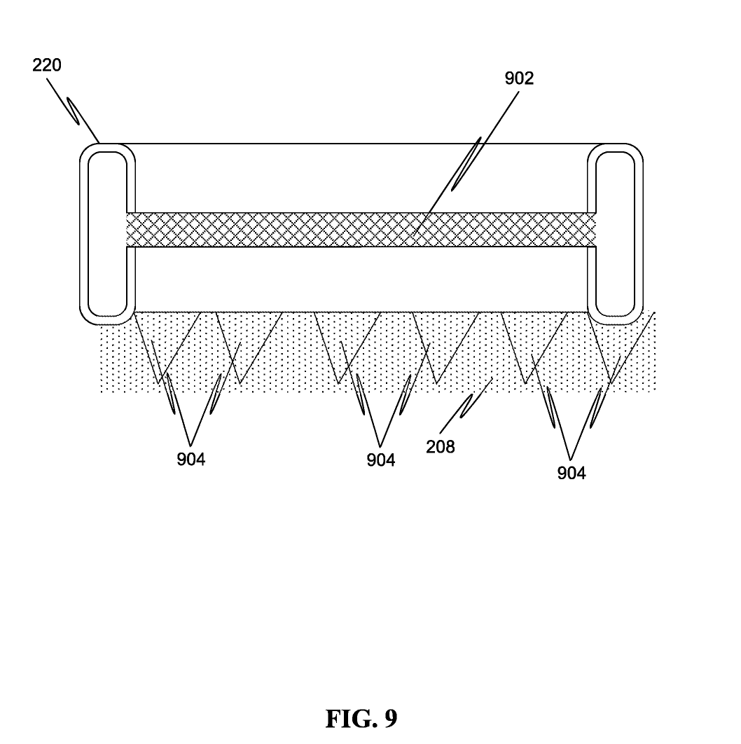

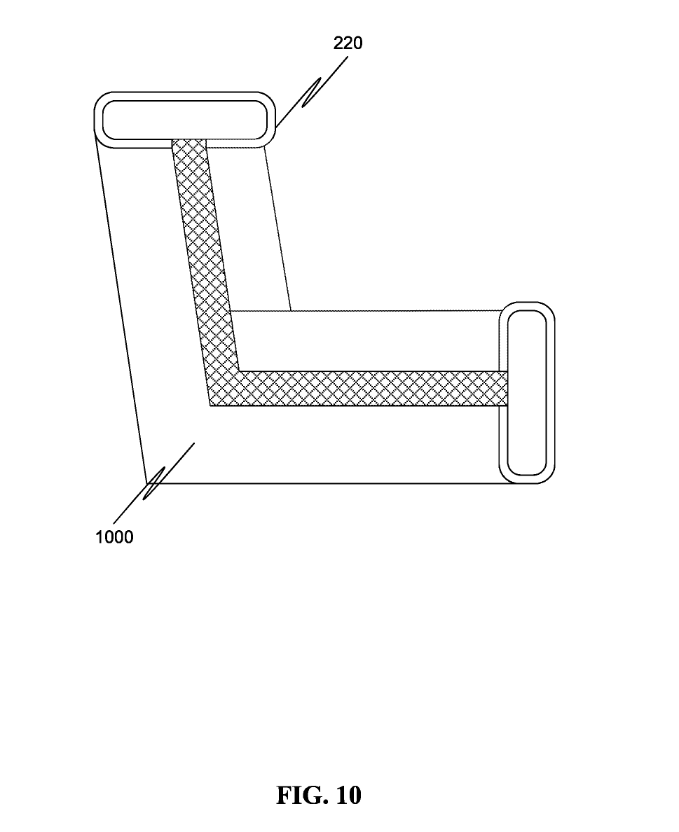

In some embodiments, the apparatus 114 may further include one or more guide-rails 220 configured to be slidably coupled to at least one edge of the one or more protective sheets 204. For example, the one or more guide-rails 220 may be a pipe with an opening 902 (shown in FIG. 9) to couple with the at least one edge of the one or more protective sheets 204. Further, the one or more guide-rails 220 may include a securing means configured to secure the one or more guide-rails 220 to a surface. For example, the securing means may include protrusions 904 cemented in the ground 208 to secure the one or more guide-rails 220 to the surface. FIG. 10 shows the one or more guide-rails 220 with a bend 1000. Accordingly, the one or more guide-rails 220 may go around the perimeter of the structure 202.

Further, the one or more guide-rails 220 may include a magnet. Yet further, the at least one edge of the one or more protective sheets 204 may include a magnetic material. Accordingly, the magnet on the one or more guide-rails 220 may engage with the magnetic material of the one or more protective sheets 204.

In some embodiments, the one or more guide-rails 220 may include one or more stoppers disposed on one or more positions on the one or more guide-rails 220. Further, the one or more stoppers may secure the one or more protective sheets 204 at the one or more positions. Further, the one or more stoppers may be slidably coupled to the one or more guide-rails 220.

In some embodiments, the one or more actuators may include a magnetic pulley 222. Further, the magnetic pulley 222 may be configured to be coupled to the one or more guide-rails 220. Moreover, the one or more actuators may include a vertical magnetic pulley 224. For example, the one or both the magnetic pulleys 222 and 224 may be placed inside the one or more guide-rails 220.

In some embodiments, the apparatus 114 may further include one or more end-locks configured to be disposed on the structure 202. Further, the one or more end-locks may be configured to engage with at least one edge of the one or more protective sheets 204 to secure the one or more protective sheets 204 in the extended state. The one or more end-locks secure the one or more protective sheets 204 to the structure 202. The one or more end-locks may help protect the structure 102 if the one or more protective sheets 204 are unable to go all the way around the structure 102.

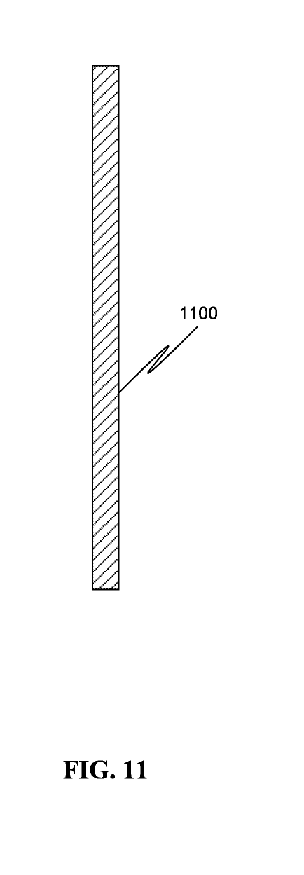

In further embodiments, the apparatus 114 may include one or more magnetic locks 1100 (shown in FIG. 11) disposed on at least one edge of the one or more protective sheets 204 to secure the one or more protective sheets 204 in the extended state. The power supply may be required to hold the one or more magnetic locks 1100. Accordingly, the one or more magnetic locks 1100 may be activated/deactivated when required. Therefore, the one or more magnetic locks 1100 may be activated when the one or more protective sheets 204 need to be secured. Further, the one or more magnetic locks 1100 may be deactivated when the one or more protective sheets 204 need to be released.

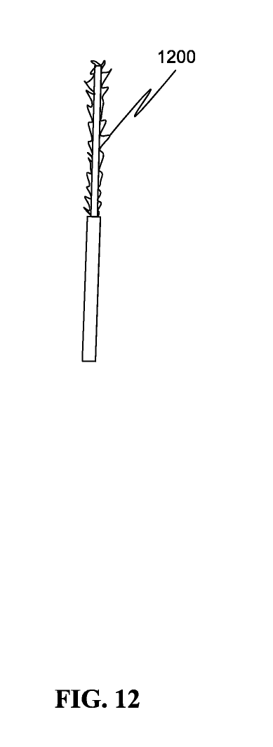

In some embodiments, the apparatus 114 may further include one or more brushes 1200 (shown in FIG. 12) configured to operatively engage with a surface of the one or more protective sheets 204 during transition of the one or more protective sheets 204 from one of the collapsed state and the extended state to an opposite state. The one or more brushes 1200 may remain stationary, while the one or more protective sheets 204 move during the transition. Therefore, the one or more brushes 1200 may be configured to clear the surface of debris. The one or more brushes 1200 may be included in the one or more holders 206.

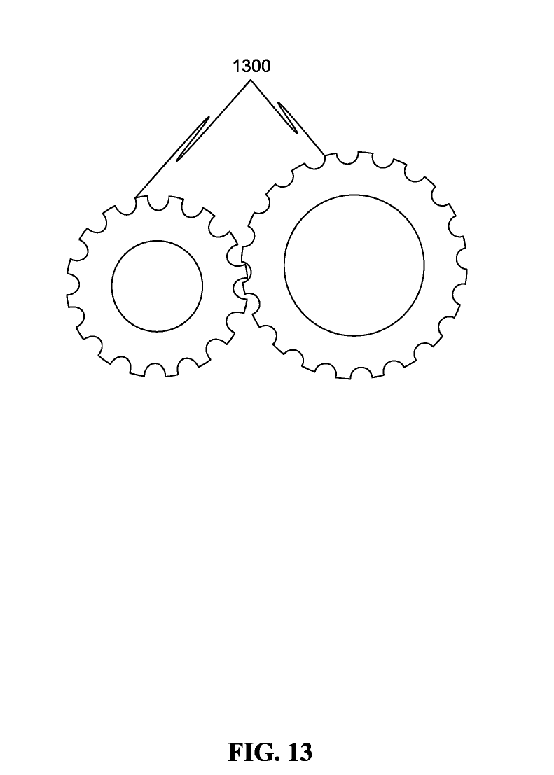

In some embodiments, the one or more actuators (not shown) may further include push wheels 1300 (shown in FIG. 13) configured to push the one or more protective sheets 204 during a transition from one of the collapsed state and the extended state to an opposite state.

In some embodiments, at least one extent associated with the extended state of the one or more protective sheets 204 may be based on the one or more user inputs. According, a user may control the extent to which the second protective sheet 214 may rise. For example, in a flood situation, the user may lower the second protective sheet 214 such that a boat may approach the structure 202 and rescue the occupant(s).

The apparatus 114 may further include electronic components and circuit 226 to operate the various electrical parts of the apparatus 114. The electronic components and circuit 226 may couple the one or more actuators and the one or more power sources 210. Further, the electronic components and circuit 226 may include the one or more sensors configured to detect an environmental variable

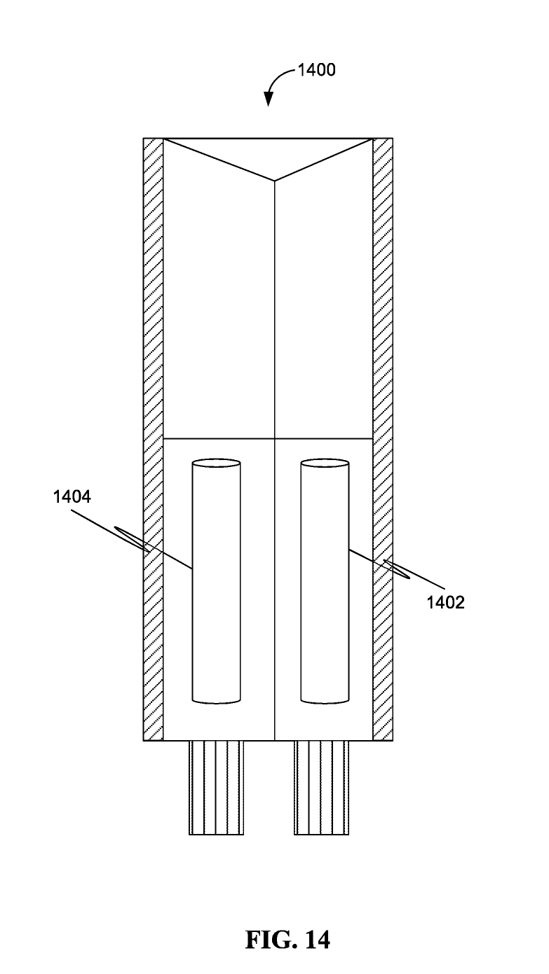

FIG. 14 illustrates a holder 1400 in the one or more holders 206 in accordance with an exemplary embodiment. The holder 1400 includes two protective sheets 1402-1404. The two protective sheets 1402-1404 come out of the holder 1400 in opposite directions, go around the perimeter of the structure 202, meet near the halfway point on the perimeter of the structure 202 and lock together. Then they both rise up towards the roof to lock with a magnetic strip on the roof.

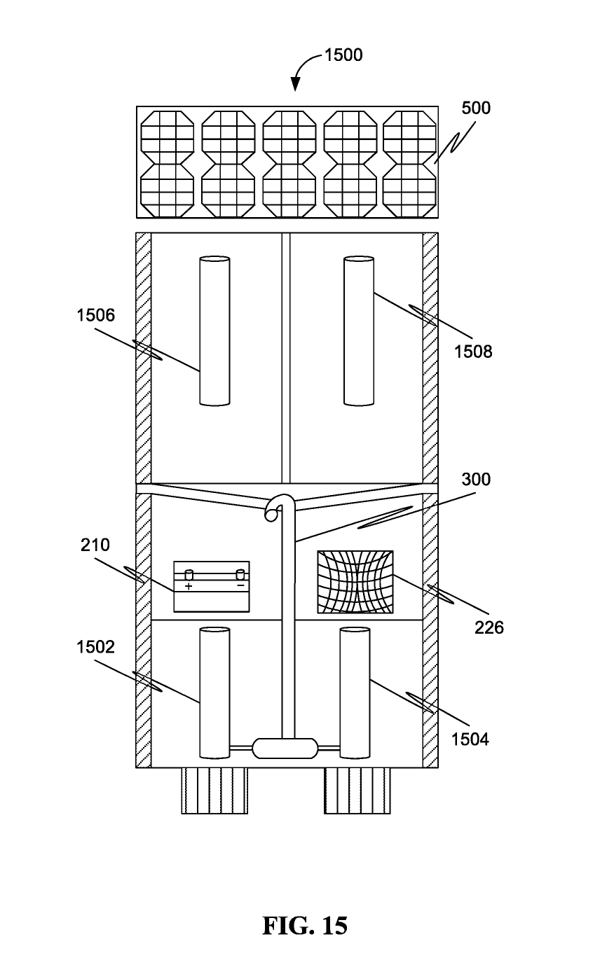

FIG. 15 illustrates a holder 1500 in the one or more holders 206 in accordance with an exemplary embodiment. The holder 1500 may include one or more protective sheets 1502-1504 for a first floor. Further, the holder 1500 may include one or more protective sheets 1506-1508 for a second floor. Similarly, more floors could be protected by the disclosed apparatus 114.

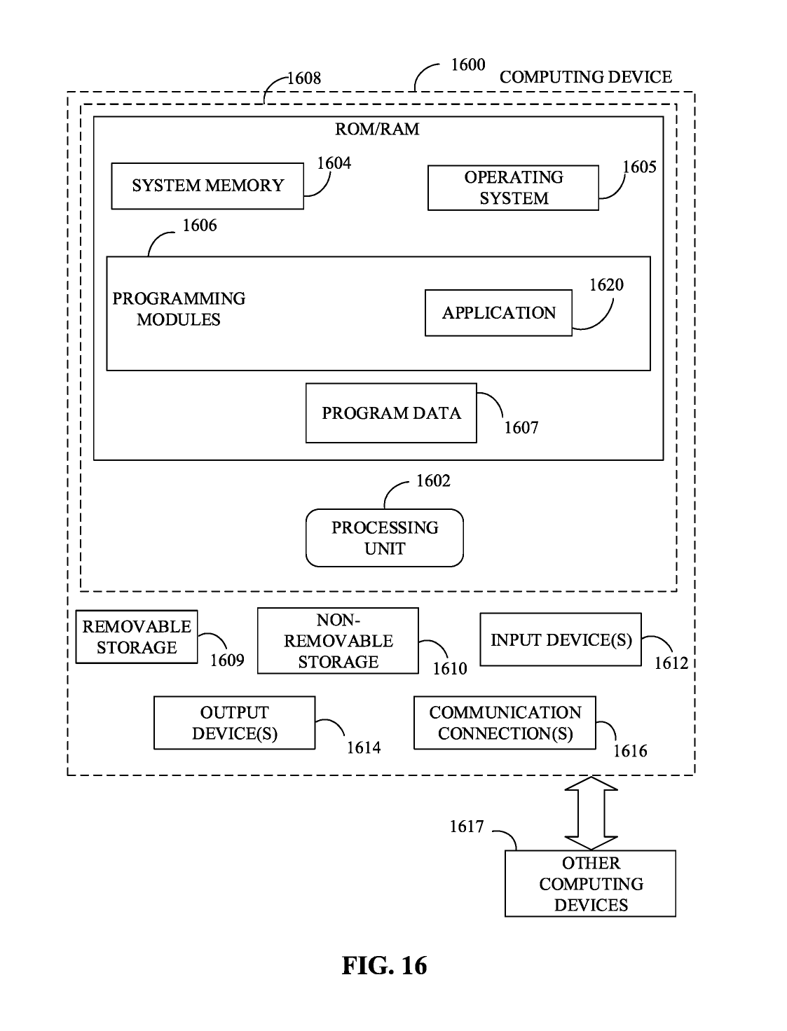

FIG. 16 is a block diagram of a system including computing device 1600. Consistent with an embodiment of the disclosure, the aforementioned memory storage and processing unit may be implemented in a computing device, such as computing device 1600 of FIG. 16. Any suitable combination of hardware, software, or firmware may be used to implement the memory storage and processing unit. For example, the memory storage and processing unit may be implemented with computing device 1600 or any of other computing devices 1618, in combination with computing device 1600. The aforementioned system, device, and processors are examples and other systems, devices, and processors may comprise the aforementioned memory storage and processing unit, consistent with embodiments of the disclosure.

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and nonvolatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620) may perform processes including, for example, one or more stages of methods, algorithms, systems, applications, servers, databases as described above. The aforementioned process is an example, and processing unit 1602 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/We claim:

1. An apparatus for providing protection to a structure, the apparatus comprising:
at least one protective sheet configured to be maintained in one of a collapsed state and an extended state, wherein in the extended state, the at least one protective sheet is configured to cover at least a portion of the structure, wherein the at least one protective sheet is configured to protect the portion of the structure from an environmental adversity;
at least one holder configured to house the at least one protective sheet, wherein the at least one holder is further configured to be secured to at least one of the structure and the ground;
at least one actuator configured to transition the at least one protective sheet from one of the collapsed state and the extended state to an opposite state;
at least one power source configured to supply electric power to the at least one actuator; and
at least one switch communicatively coupled the at least one actuator and the at least one power source, wherein the at least one switch is configured to control supply of power to the at least one actuator based on at least one user input.

2. The apparatus of claim 1 further comprising:
a wireless communication device configured to receive at least one command over a communication channel; and
a processing device communicatively coupled to the wireless communication device, wherein the processing device is configured to interpret the at least one command, wherein the processing device is further communicatively coupled to the at least one switch, wherein the processing device is configured to control a state of the at least one switch based on the at least one command.

3. The apparatus of claim 1, wherein the at least one protective sheet comprises at least one light source configured to produce light according to at least one pattern, wherein the at least one pattern is based on a user input of the at least one user input.

4. The apparatus of claim 2, wherein the wireless communication device is further configured to receive weather data associated with a location of the structure from at least one weather database, wherein the processing device is further configured to analyze the weather data and control a state of the at least one switch based on analysis of the weather data.

5. The apparatus of claim 2 further comprising at least one sensor configured to detect an environmental variable, wherein the at least one sensor is communicatively coupled to the processing device, wherein the processing device is further configured to analyze the environmental variable and control a state of the at least one switch based on analysis of the environmental variable.

6. The apparatus of claim 5, wherein the wireless communication device is further configured to transmit the environmental variable to a user device over the communication channel.

7. The apparatus of claim 1 further comprising at least one solar panel disposed over the at least one protective sheet, wherein the at least one power source comprises the solar panel.

8. The apparatus of claim 1, wherein the at least one protective sheet comprises a plurality of protective sheets, wherein the at least one actuator comprises a plurality of actuators, wherein a first protective sheet of the plurality of protective sheets is configured to cover a first portion of the structure, wherein a second protective sheet of the plurality of protective sheets is configured to cover a second portion of the structure, wherein supply of power to the first actuator is independent of supply of power to the second actuator.

9. The apparatus of claim 1, wherein the at least one protective sheet comprises a plurality of protective sheets, wherein a first protective sheet of the plurality of protective sheets is configured to accommodate a second protective sheet of the plurality of protective sheets, wherein the at least one actuator comprises a first actuator configured to transition the first protective sheet from one of the collapsed state and the extended state to an opposite state, wherein the at least one actuator further comprises a second actuator configured to transition the second protective sheet from one of the collapsed state and the extended state to an opposite state.

10. The apparatus of claim 9, wherein the second protective sheet is configured to be inflatable, wherein the collapsed state of the second protective sheet comprises a deflated state, wherein the extended state of the second protective sheet comprises an inflated state, wherein the second actuator comprises an air pump configured to control volume of air contained within the second protective sheet.

11. The apparatus of claim 10, wherein a first direction of movement associated with the transition of the first protective sheet is orthogonal to a second direction of movement associated with the transition of the second protective sheet.

12. The apparatus of claim 1, wherein the at least one actuator comprises:
a shaft coupled to the at least one protective sheet, wherein rotation of the shaft causes at least one of winding and unwinding of the at least protective sheet around the shaft; and
at least one electric motor rotatably coupled to the shaft, wherein the at least one electric motor is configured to rotate the shaft.

13. The apparatus of claim 1 further comprising at least one guide-rail configured to be slidably coupled to at least one edge of the at least one protective sheet, wherein the at least one guide-rail comprises a securing means configured to secure the at least one guide-rail to a surface.

14. The apparatus of claim 13, wherein the at least one guide-rail comprises a magnet, wherein the at least one edge of the at least one protective sheet comprises a magnetic material.

15. The apparatus of claim 13, wherein the at least one guide-rail comprises at least one stopper disposed on at least one position on the at least one guide-rail, wherein the at least one stopper secures the at least one protective sheet at the at least one position, wherein the at least one stopper is slidably coupled to the at least one guide-rail.

16. The apparatus of claim 15, wherein the at least one actuator comprises a magnetic pulley, wherein the magnetic pulley is configured to be coupled to the at least one guide-rail.

17. The apparatus of claim 1 further comprising at least one end-lock configured to be disposed on the structure, wherein the at least one end-lock is configured to engage with at least one edge of the at least one protective sheet to secure the at least one protective sheet in the extended state.

18. The apparatus of claim 1 further comprising at least one brush configured to operatively engage with a surface of the at least one protective sheet during transition of the at least one protective sheet from one of the collapsed state and the extended state to an opposite state, wherein the at least one brush is configured to clear the surface of debris.

19. The apparatus of claim 1, wherein at least one extent associated with the extended state of the at least one protective sheet is based on the at least one user input.

20. The apparatus of claim 1, wherein the at least one protective sheet is transparent to visible light.
